(19) United States
(12) Patent Application Publication
(10) Pub. No.: US 2024/0399227 A1
(43) Pub. Date: Dec. 5, 2024

(54) SYSTEMS AND METHODS FOR PREDICTING THE FLIGHT OF A GOLF BALL

(71) Applicant: SUMITOMO RUBBER INDUSTRIES, LTD., Kobe (JP)

(72) Inventors: William Mark MCNALLY, Huntington Beach, CA (US); Jacob Lambeth, Huntington Beach, CA (US); Dustin Brekke, Huntington Beach, CA (US)

(73) Assignee: SUMITOMO RUBBER INDUSTRIES, LTD., Kobe (JP)

(21) Appl. No.: 18/732,319

(22) Filed: Jun. 3, 2024

Related U.S. Application Data
(60) Provisional application No. 63/470,239, filed on Jun. 1, 2023.

(51) Int. Cl. A63B 69/36; A63B 24/00

(52) U.S. Cl. CPC A63B 69/3658; A63B 2024/0056; A63B 2220/35

(57) ABSTRACT

Systems and methods receive first data associated with first launch conditions of a first golf ball after the first golf ball moves from a first initial position. The systems and methods determine a simulated landing position of the first golf ball, the simulated landing position determined based at least in part on the launch conditions. The systems and methods receive an actual landing position of the first golf ball, determine second data associated with an error between the simulated landing position and the actual landing position, and train a machine learning model using the error between the simulated landing position and the actual landing position. The systems and methods receive third data associated with second launch conditions of a second golf ball after the second golf ball moves from a second initial position, and determine, based at least in part on inputting the third data into the trained machine learning model, a predicted landing position of the second golf ball.

This application is a non-Provisional of U.S. Provisional Application No. 63/470,239, filed Jun. 1, 2023, which is incorporated herein by reference in its entirety.

### BACKGROUND

Physics models and simulations (e.g., computational fluid dynamics, finite element analysis, contact models, biomechanical models, etc.) play a fundamental role in sports engineering and serve as a vital tool for innovation, especially in regards to the design of sporting equipment. These dynamic models often include physical parameters or variables (e.g., aerodynamic coefficients, material properties, forces, etc.) whose values are unknown and need to be identified using empirical data. Identifying these parameters directly often requires rigorous experiments, so a common approach is to perform indirect parameter identification using measurements that are easier to obtain.

In this respect, there have been many different models and approaches used to estimate the trajectory and landing position of a golf ball. Related Art 1 showed that driver distance could be estimated as a function of ball speed. Related Art 2 developed a numerically integrated model using lift and drag. Related Art 3 used optimization routines to determine launch conditions to maximize carry. Related Art 4 included spin rate decay and nonlinear drag dependence on Reynold's number. Related Art 5 examined the cross-dependence of Reynold's number and spin ratio for estimating drag and lift coefficients. Various ball trajectory models have also been extended to three dimensions to accurately capture the curve of ball flight. Developing a ball flight model generally requires accurate prediction of aerodynamic coefficients such as drag and lift coefficients, for example. There have been many studies and experiments to measure these coefficients in controlled environments. Others have calculated drag and lift coefficients computationally. With the introduction of radar-based launch monitors, which can measure the launch conditions and ball position over the entire course of its flight, much larger and diverse datasets can be obtained. Related Art 6 examined the effect of dimple design on the outdoor flight trajectory of golf balls using a TrackMan. Related Art 7 implemented an artificial neural network to map launch conditions to carry distance, offline distance, and apex height. This model, however, had low accuracy and did not capture the full flight of the golf ball.

Recently, deep learning has been applied to modeling fields. See Related Art 8.

### SUMMARY

According to the above conventional methods, however, when the parameter in question is a function of the system states, the designer imposes an inductive bias on the model when choosing an appropriate target function. For example, the designer may choose a linear regression model when the true nature of the parameter may be highly complex and non-linear. Deep learning and artificial neural networks present an opportunity to learn parameters in physics simulations without making assumptions about their true nature.

Despite the recent popularity of deep learning and its apparent suitability for parameter identification, its use in physics models and simulations is remarkably scarce. The traditional application of deep learning would ignore the underlying physics, which could lead to implausible results. A better approach is to insert deep learning models into the differential equations governing a dynamical system (i.e., the equations of motion). Thus exemplary embodiments of the inventive principles described herein approximate an inverse model by representing unknown functions in the dynamic equations using feed-forward networks.

In particular, exemplary embodiments provide systems and methods implemented by one or more computing devices that receive first data associated with first launch conditions of a first golf ball after the first golf ball moves from a first initial position. The systems and methods determine a simulated landing position of the first golf ball, the simulated landing position determined based at least in part on the launch conditions. The systems and methods receive an actual landing position of the first golf ball, determine second data associated with an error between the simulated landing position and the actual landing position, and train a machine learning model using the error between the simulated landing position and the actual landing position. The systems and methods receive third data associated with second launch conditions of a second golf ball after the second golf ball moves from a second initial position, and determine, based at least in part on inputting the third data into the trained machine learning model, a predicted landing position of the second golf ball.

### BRIEF DESCRIPTION OF THE DRAWINGS

The file of this patent contains at least one drawing executed in color. Copies of this patent with color drawings will be provided by the Office upon request and payment of the necessary fee.

Exemplary embodiments of the broad inventive principles described herein will now be described with respect to the following figures, wherein:

FIG. 1 is an overview of an exemplary systems and methods;

FIG. 2 is an overview of an exemplary method;

FIG. 3 is a histogram of the club types used in an exemplary dataset;

FIG. 4 shows exemplary normalized histograms for the datasets used arising from the club types used in the golf tests;

FIG. 5 shows exemplary mean landing position errors resulting from comparative examples;

FIG. 6 shows exemplary normalized histograms demonstrating the error reduction attributable to the exemplary method as compared to the comparative examples;

FIG. 7 shows exemplary lift and drag coefficients predicted according to the exemplary method; and

FIGS. 8A and 8B are a flowchart summarizing the exemplary method and exemplary application.

### DETAILED DESCRIPTION OF EXEMPLARY EMBODIMENTS

Accurately predicting the flight of a golf ball has great utility within the golf industry. Camera-based launch monitors, such as the GCQuad from, capture the initial conditions of the golf ball, but they can only see a very short distance after impact. A model must be used to predict the remaining flight of the ball. Radar-based launch monitors, such as a TrackMan, capture the full flight of the golf ball. However, a ball flight model must be used when indoors or when the launch monitor cannot capture the full flight of the ball. Additionally, players can make use of a “normalized” output, where the ball flight is adjusted for environmental conditions such as wind, altitude, and temperature.

Ball flight models are also used by ball and club manufacturers to improve the performance of their products. Clubhead properties, such as face curvature, center of gravity, and moments of inertia, can directly affect the launch conditions of the golf ball after impact. An accurate flight model can be used by a club manufacturer to tune these properties to maximize distance or accuracy. A ball manufacturer may use a flight model to more efficiently design a ball's dimple pattern. Ball flight models have also been used to tune biomechanical golfer models.

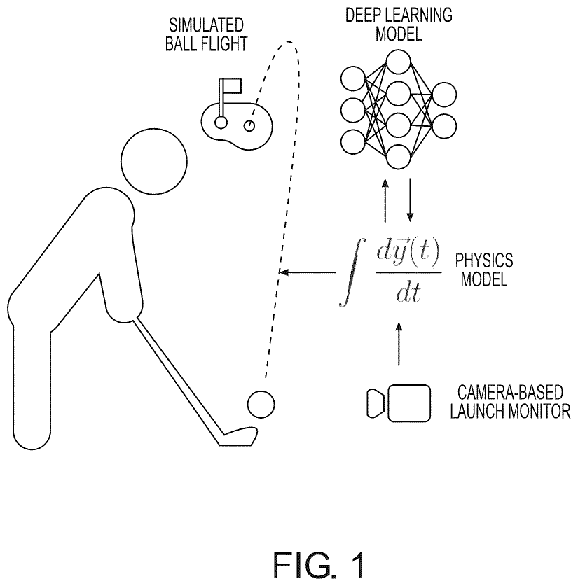

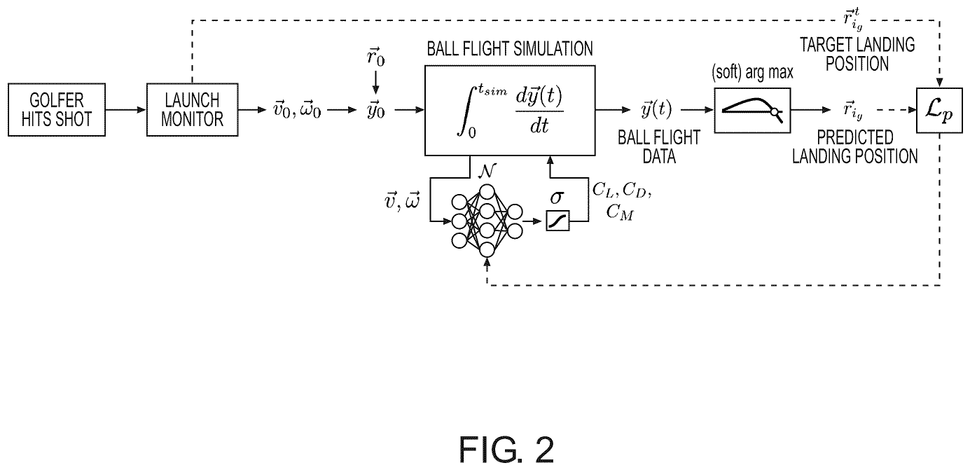

Although a statistical model can also be used to estimate the ball's landing position, physics-based flight models provide a variety of benefits. By calculating the full trajectory of the golf ball, visual feedback is provided to the player, which allows them to play and practice virtually. Physics-based flight models can also determine the landing conditions (velocity and spin) of the golf ball more easily. FIG. 1 generally shows and exemplary embodiment that integrates a neural network into a physics model of a golf ball in flight. An overview of such an approach is given in FIG. 2. The solid arrows reflect how the model is used during inference and the dashed arrows reflect the flow of information during training. The following exemplary method utilizes a physics model and the aerodynamic forces acting on the golf ball, a deep learning model used to estimate the aerodynamic coefficients applied within the physics model, and applies the integration of physics and deep learning models for simulating multiple golf ball trajectories in parallel to obtaining final landing positions.

The reference coordinate system used for the physics model has the X axis pointing away from a right-handed golfer, the Y axis pointing at the target, and the Z axis pointing towards the sky. The notation used is as follows. A three-dimensional vector a [symbol] ∈ [symbol] points in the direction

$$\hat{u} = \frac{\vec{u}}{‖ \vec{u} ‖}$$

A continuous time series of [symbol] vectors is denoted as [symbol] (t). A discrete time step i of [symbol] (t) is denoted as [symbol] ᵢ and has components [symbol] _{i,x}. [symbol] _{i,y} [symbol] _{i,z}.

### I. Physics Model

The physical system is modeled using ordinary differential equations (ODEs), wherein a golf ball with mass m, radius R position [symbol] (t), and velocity [symbol] (t) is treated as a particle and obeys Newton's second law of motion:

$$\frac{d \vec{v} ( t )}{dt} = \frac{\vec{F} ( t )}{m} \qquad ( 1 )$$

where

$$\vec{v} ( t ) = \frac{d \vec{r} ( t )}{dt} .$$

The golf ball also has a spin [symbol] (t) that decays over time due to an aerodynamic spin decay torque [symbol] (t):

$$\frac{d \vec{ω} ( t )}{dt} = \frac{\vec{T} ( t )}{I} \qquad ( 2 )$$

where

$$I = \frac{2}{5} {mR}^{2}$$

is the mass moment of inertia of the golf ball. The aerodynamic forces include the lift force [symbol] _{L} and the drag force [symbol] _{D}. For convenience, the “(t)” notation is temporarily dropped with the understanding that all forces and states are time-varying. The drag force acts in the direction opposing the velocity of the golf ball (−\hat{v}), and the lift force acts perpendicular to the velocity and spin, in the direction

$$\frac{\vec{v} \times \vec{ω}}{‖ \vec{v} \times \vec{ω} ‖} .$$

The magnitudes of the aerodynamic forces and spin decay torque are related to the dynamic air pressure q, the cross-sectional area of the golf ball A=πR², and the dimensionless aerodynamic coefficients C_{L}, C_{D}, and C_{M}. The dynamic air pressure is defined as:

$$q = \frac{1}{2} ρ {‖ \vec{v} ‖}^{2} \qquad ( 3 )$$

where ρ is the air density. Finally, the aerodynamic forces are defined using the equations below:

$${\vec{F}}_{L} = {C}_{L} q A \frac{\vec{v} \times \vec{ω}}{‖ \vec{v} \times \vec{ω} ‖} \qquad ( 4 )$$

$${\vec{F}}_{D} = - {C}_{D} q A \hat{v} \qquad ( 5 )$$

$$\vec{T} = - {C}_{M} q d A \hat{ω} \qquad ( 6 )$$

where d is the golf ball diameter. The net force [symbol] acting on the golf ball is the sum of the aerodynamic forces and the constant force of gravity [symbol] =−mg\hat{k}:

$$\vec{F} = {\vec{F}}_{L} + {\vec{F}}_{D} + \vec{G} . \qquad ( 7 )$$

### II. Deep Learning Model

At each time step of the ball flight simulation, a fully-connected feed-forward neural network, otherwise known as a multilayer perceptron, is used to estimate the aerodynamic coefficients. The inputs to the network are the velocity and spin states [symbol] and [symbol] , which are normalized through division by 89.4 m/s (200 mph) and 2094 rad/s (20 k rpm), [symbol] respectively. It was found that this normalization scheme stabilized training by ensuring the inputs to the network were bounded between 0 and 1 (typical ball speeds and spin rates in golf lie below these upper bounds—a description of the dataset used in this study is provided below. In the base configuration, labeled Phys-NN, the neural network N has two hidden layers with 256 and 128 units, respectively, and uses the rectified linear unit (ReLU) activation function after each hidden layer. The output layer returns the intermediate features C′_{L}, C′_{D}, and C′_{M}:

$${C}_{L}^{′} , {C}_{D}^{′} , {C}_{M}^{′} = ( \vec{v} , \vec{ω} ) \qquad ( 8 )$$

The actual aerodynamic coefficients C_{L}, C_{D}, and C_{M} are obtained by passing the intermediate features through a sigmoid function and dividing by 2, 2, and 50, respectively:

$${C}_{L} = σ ( {C}_{L}^{′} ) / 2 \qquad ( 9 )$$

$${C}_{D} = σ ( {C}_{D}^{′} ) / 2 \qquad ( 10 )$$

$${C}_{M} = σ ( {C}_{D}^{′} ) / 50 \qquad ( 11 )$$

This was done to constrain the ranges of the potential values for C_{L}, C_{D}, and C_{M} based on values observed in previous work. C_{L} and C_{D} are constrained to [0, 0.5], whereas C_{M} is constrained to [0, 0.02].

A number of variations to the base neural network configuration are evaluated later in this disclosure. Specifically, the effects of varying the number of hidden layers and hidden units, among other architectural changes, including predicting a fourth aerodynamic coefficient C_{Q} that varies the dynamic air pressure (i.e., q=C_{Q}ρ∥ [symbol] ∥²) are evaluated. The effects of changing various training hyperparameters, including the batch size and loss function, are also investigated.

### III. Simulation and Training

This section describes how the physics model and the deep learning model are jointly applied to simulate golf ball flight paths. The entire system was implemented in PyTorch version 1.13 and is differentiable from end to end (i.e., from the launch conditions to the final landing positions), permitting the neural network, which estimates the aerodynamic coefficients at each time step, to be trained using only measured launch conditions and landing positions.

Set up as an initial value problem, the physics simulation begins with the launch conditions of the golf ball, namely the ball speed ∥ [symbol] _{O}∥, launch angle γ, azimuth ϕ, back spin ω_{0,x}, and side spin [symbol] . These launch conditions are typically measured using commercially available launch monitors. The third spin component ω_{0,y}, known as rifle spin, is considered to be less relevant to the flight of the golf ball and is therefore typically not provided by launch monitors. For the purpose of this example, ω_{0,y} is assumed to be zero. The components of the initial golf ball velocity [symbol] _{O} are computed as:

$${\vec{v}}_{0} = [ \begin{matrix}{v}_{0 , x} \\ {v}_{0 , y} \\ {v}_{0 , z}\end{matrix} ] = [ \begin{matrix}‖ {\vec{v}}_{0} ‖ cos ( γ ) sin ( ϕ ) \\ ‖ {\vec{v}}_{0} ‖ cos ( γ ) cos ( ϕ ) \\ ‖ {\vec{v}}_{0} ‖ sin ( γ )\end{matrix} ] \qquad ( 12 )$$

The initial state of the system [symbol] _{O} comprises nine time-dependent variables, including the components of [symbol] _{O}, [symbol] _{O}, and the initial ball position [symbol] _{O}, which is set to [0,0,1]^{T} cm to account for the tee height and to facilitate a check for the ball crossing the ground plane. By extension, the state of the system at any time t is [symbol] (t)=[ [symbol] (t), [symbol] (t), [symbol] (t)]. When the wind velocity [symbol] is known, the golf ball velocity [symbol] (t), can be replaced with its velocity relative to the wind: [symbol] (t)= [symbol] (t)− [symbol] .

To facilitate the simulation of multiple flights in parallel, a vectorized implementation of Euler's method is used to numerically integrate a batch of flights from 0 to tₛᵢₘ seconds using a fixed time step Δt:

$$( t + Δ t ) = ( t ) + Δ t \frac{d ( t )}{dt} \qquad ( 13 )$$

where:

$$\frac{d ( t )}{dt} = [ \begin{matrix}\frac{d \vec{v} ( t )}{dt} \\ \frac{d \vec{ω} ( t )}{dt} \\ \frac{d \vec{r} ( t )}{dt}\end{matrix} ] = [ \begin{matrix}\frac{\vec{F} ( t )}{m} \\ - \frac{\vec{T} ( t )}{I} \\ \vec{v} ( t )\end{matrix} ] \qquad ( 14 )$$

Since [symbol] and [symbol] depend on the aerodynamic coefficients, a forward pass through the neural network is performed at each time step. Hence,

$$\frac{{t}_{s i m}}{Δ t}$$

passes through the neural network are required to complete the simulation, after which the loss is computed. In experiments involving a physics-only baseline model (comparative example discussed below), it was found that setting Δt=0.1 s provided adequate convergence of the golf ball landing position. Decreasing Δt further negatively affects the performance of the proposed method by increasing the number of times the neural network needs to be called, which slows down the simulation, increases memory usage, and makes the training process more susceptible to exploding and vanishing gradients. The simulation time tₛᵢₘ was set to 10 s, which is longer than all the flight times in the dataset discussed below. As a result, the neural network is called 100 times per batch of simulated flights.

An exemplary method for training the neural network using the minimum amount of information, namely the launch conditions and landing positions is described below. Such data is easily obtained using radar-based launch monitors (e.g., a TrackMan or FlightScope). A camera-based launch monitor, such as the GCQuad, could also be used to collect launch conditions together with manually recorded landing positions. Admittedly, a more effective approach to training the network would be to minimize the position error over full flight paths; however, such data can only obtained with special access to the APIs of radar-based launch monitors. Instead, readily available ball flight metadata that radar-based launch monitors provide by default is used. In addition to using the landing position error, an additional loss based on the max height of the shot is used.

To index the time at which the golf ball crosses the ground plane in a differentiable manner, we implement a custom soft-argmax operation and apply it to the height of the golf ball [symbol] (t). More specifically, the time step index i_{g}∈W at which the golf ball is closest to the ground is computed as:

$${i}_{g} = {i}_{g} + arg max ( - \vert {r}_{{i}_{g} : end , z} \vert ) \qquad ( 15 )$$

where iₛ∈W is a starting index used to prevent the soft-argmax operation from returning an index near the beginning of the flight when the golf ball is close to the ground. A value of

$$⌊ \frac{1}{Δ t} ⌋ ,$$

corresponding to t=1 s, was arbitrarily chosen for iₛ. During validation and inference, i_{g} is obtained using a standard arg max and the final ball state is refined by interpolating [symbol] (t) to r_{z}=0. The interpolation step is omitted during training under the assumption that the mean landing position error resulting from a lack of interpolation is close to zero. It follows that the landing position error [symbol] ₚ is computed as:

$${ℒ}_{p} = ‖ {\vec{r}}_{{i}_{g}} - {\vec{r}}_{{i}_{g}}^{t} ‖ \qquad ( 16 )$$

where [symbol] is the target landing position provided by the launch monitor. We additionally consider the effects of adding a loss for the max height of the golf ball:

$${ℒ}_{h} = \vert max ( {r}_{z} ) - max ( {r}_{z}^{t} ) \vert \qquad ( 17 )$$

with equal weighting such that the total loss is:

$$ℒ = {ℒ}_{p} + {ℒ}_{h} \qquad ( 18 )$$

During training, the losses are averaged over the batch of simulated flights.

### IV. Examples

Next, the following are described: the dataset used to evaluate the exemplary method; re-implementation of two published baseline models for use as comparative examples; analysis of the accuracy of the exemplary methods obtained using various model configurations and training settings; analysis of the computational efficiency of the exemplary methods; and examination of the aerodynamic coefficients.

A ball flight dataset was collected using a TrackMan 3e launch monitor to record shots during outdoor golf robot and player testing. The dataset was prepared by combining TrackMan Performance Studio reports from multiple test sessions. The reports contain measurements (and some estimates) for the club delivery, ball launch, ball flight (max height position only), and ball landing (position and velocity) for each shot. The relevant data for this study included the ball speed ∥ [symbol] |, vertical launch angle γ, horizontal launch angle ϕ (azimuth), spin rate ∥ [symbol] ∥, spin axis ψ, flat ground landing position, [symbol] max height, and flight time. The back and side components of spin are computed as ω_{0,x}=∥ [symbol] ∥cos(ψ) and ω_{0,z}=−∥ [symbol] ∥sin(ψ), respectively. Wind information was not included in the dataset ( [symbol] =0).

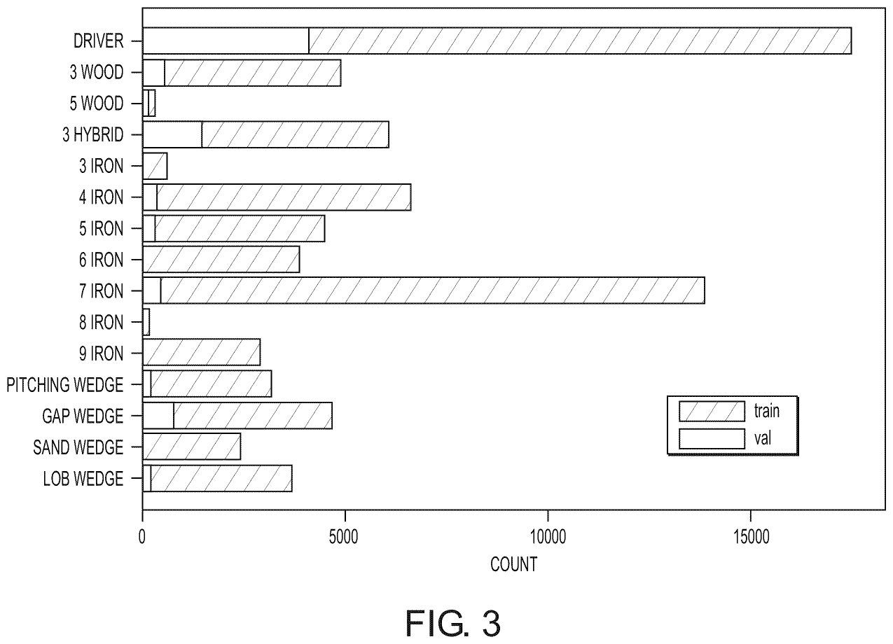

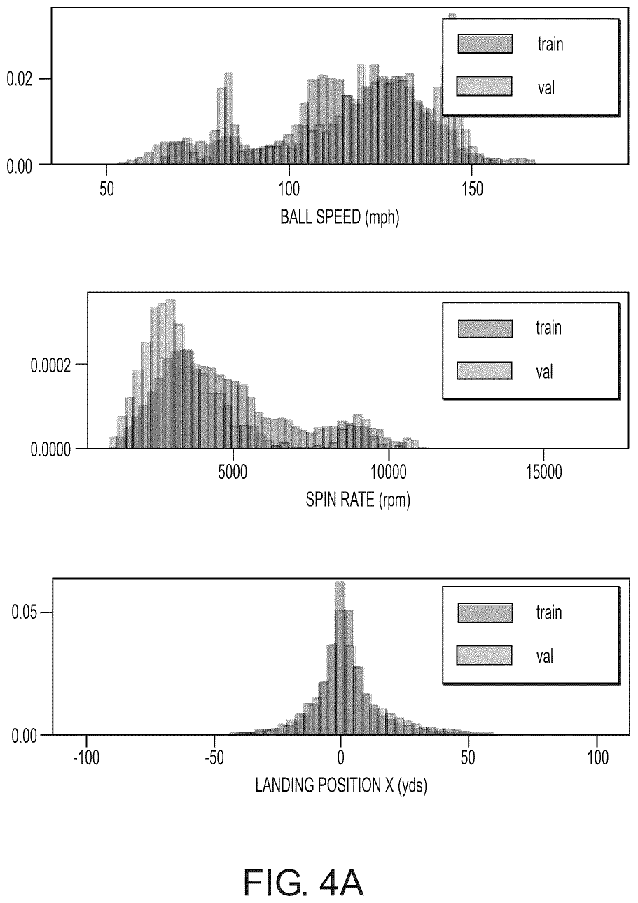

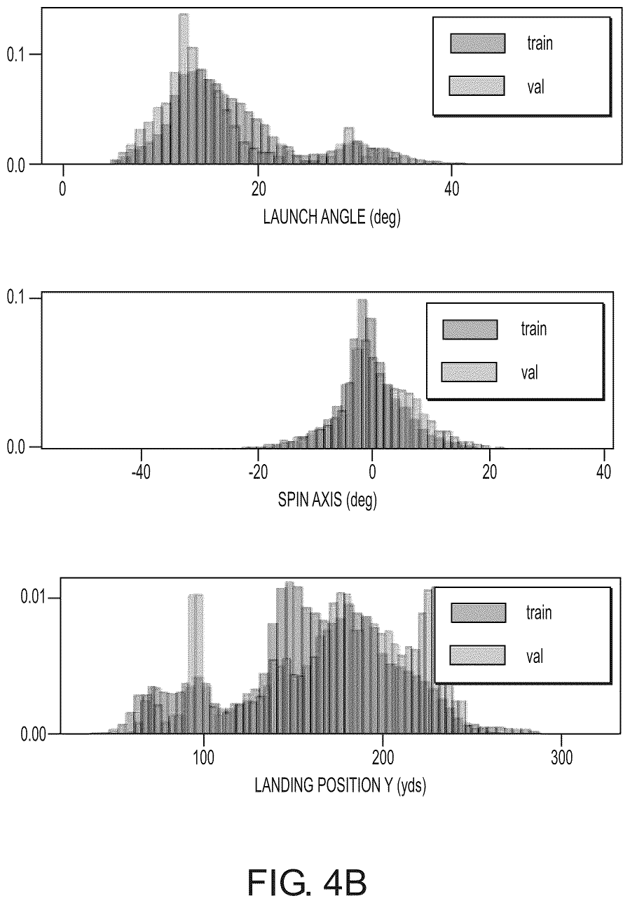

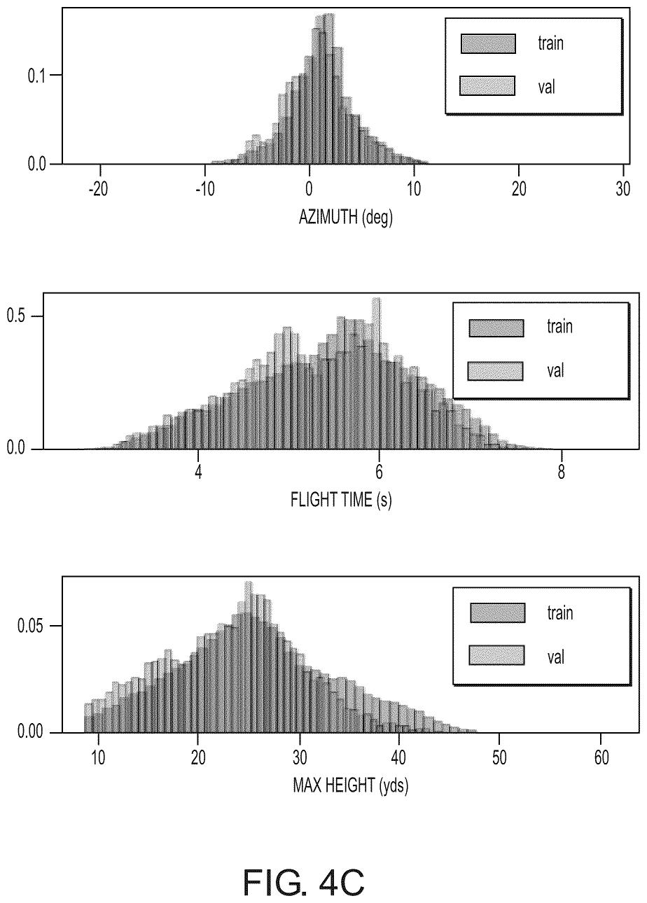

Shots with measurements deemed “invalid” by the TrackMan software were omitted from the dataset. Moreover, shots with a max height of less than 8 yds were omitted to eliminate severe mishits (e.g., tops, duffs, etc.). The final dataset contained 90,233 shots in total. A validation set was created by combining 10% of the most recent of shots (9,024 shots) from the robot and player tests. The remaining 81,209 shots were used for training. This experimental protocol was more challenging than randomly sampling shots for each subset, which led to nearly identical distributions for the training and validation sets. FIG. 4 provides normalized histograms for the relevant measurements in the dataset. The distribution patterns arise from the typical club types used in the tests (e.g., driver, 7 iron, lob wedge, etc.). A histogram of the club types used is provided in FIG. 3.

The primary error metric considered for accuracy evaluation was the mean landing position error, which is equal to the mean [symbol] ₚ on the validation set. The mean absolute max height error was considered as a secondary metric, and is equal to the mean [symbol] ₕ.

To evaluate the accuracy of the proposed approach, two prior art ball flight models were re-implemented and used as comparative examples. The first was a physics model where C_{L}, C_{M}, and C_{D} were parameterized using the spin ratio S:

$$S = \frac{R ‖ \vec{ω} ‖}{‖ \vec{v} ‖} \qquad ( 19 )$$

$${C}_{L} = {p}_{1} + {p}_{2} S + {p}_{3} {S}^{2} \qquad ( 20 )$$

$${C}_{D} = {p}_{4} + {p}_{5} S + {p}_{6} {S}^{2} \qquad ( 21 )$$

$${C}_{M} = {p}_{7} S \qquad ( 22 )$$

This comparative model was labeled Phys-Q, for “Physics-Quadratic.”

The second comparative model was a feed-forward neural network that predicted the landing position directly from the launch conditions. This approach was labeled NN and was re-implemented by modifying the neural network described above to predict the landing position directly:

$${r}_{{i}_{g} , x} , {{r}_{i}}_{g ,} = ( {\vec{v}}_{0} , {\vec{ω}}_{0} ) \qquad ( 23 )$$

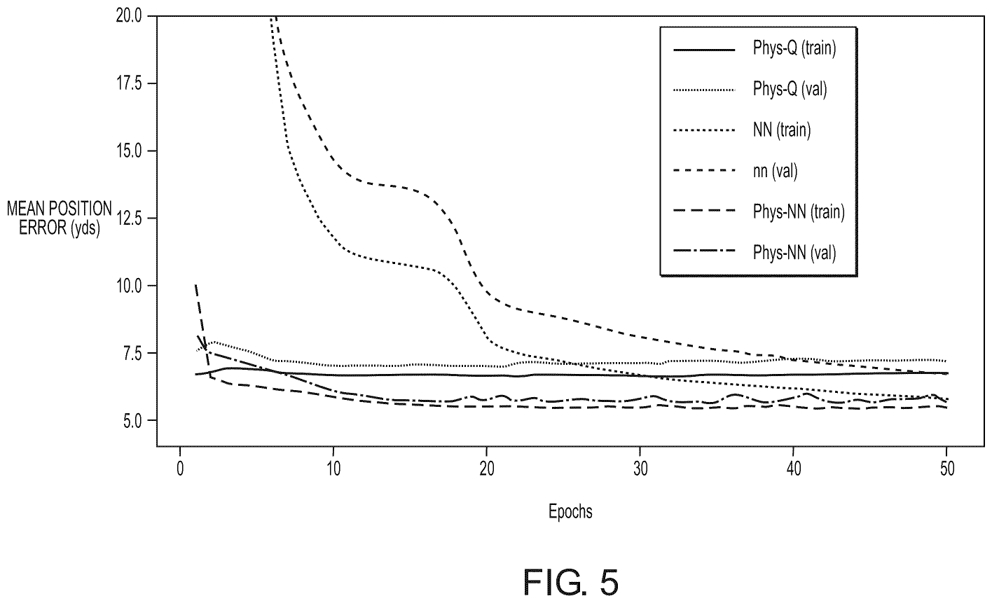

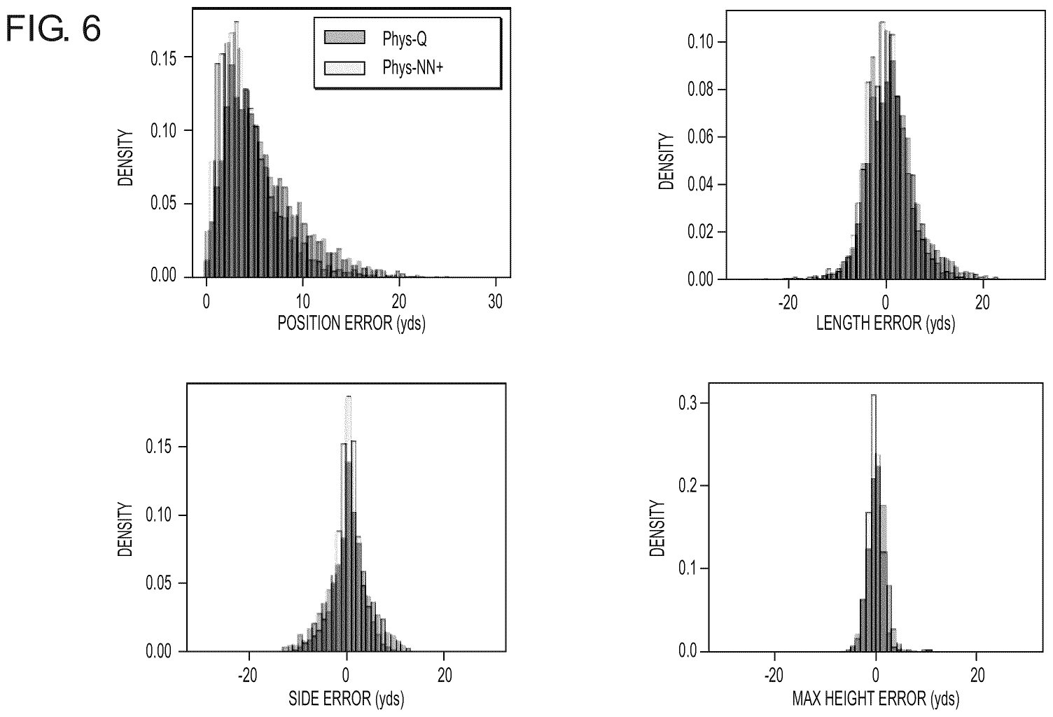

The parameters of the two baselines (Phys-Q and NN) and the base configuration of the proposed method (Phys-NN) were optimized by minimizing [symbol] ₚ over 50 epochs using stochastic gradient descent. The parameters p in Phys-Q were initialized using the optimal values found in the prior art. The default training settings included using an Adam optimizer with a constant learning rate of 0.001 and a batch size of 1024. All training was performed on an NVIDIA RTX A2000 laptop GPU. The training and validation losses (i.e., the mean landing position errors) for each comparative model are shown in FIG. 5.

The minimum validation errors for the Phys-Q, NN, and Phys-NN models were 6.95 yds, 6.70 yds, and 5.60 yds, respectively. The accuracy of NN surpassed that of Phys-Q, which was not the case in the original work of Related Art 7. It is possible that the neural network performed poorly in the original work due to the limited amount of training data.

Both neural network models outperformed the Phys-Q baseline, and the proposed Phys-NN model that combines the physical model with deep learning was the most accurate of the three; however, NN took longer to converge and it is likely that it would reach an accuracy similar to Phys-NN if trained for more epochs. Nonetheless, we reiterate that the utility of a statistical model that only predicts landing positions is limited.

This section explores the effects of modifying the architecture of Phys-NN and the training settings. First, knowing that increasing C_{L} and decreasing C_{M} both increase the lift force due to the Magnus effect, it was hypothesized that this interaction could impede the convergence of the neural network. A simplified architecture was therefore proposed:

$${C}_{L}^{′} , {C}_{D}^{′} = ( \vec{v} , \vec{ω} ) \qquad ( 24 )$$

$${C}_{M} = {p}_{M} S \qquad ( 25 )$$

where the parameter p_{M} was jointly learned while training the neural network. An additional modification was proposed in which the dynamic pressure was permitted to vary using a new aerodynamic coefficient C_{Q}:

$${C}_{L}^{′} , {C}_{D}^{′} , {C}_{Q}^{′} = ( \vec{v} , \vec{ω} ) \qquad ( 26 )$$

$${C}_{Q} = σ ( {C}_{Q}^{′} ) \qquad ( 27 )$$

$$q = {C}_{Q} ρ {‖ \vec{v} ‖}^{2} \qquad ( 28 )$$

In addition to the aforementioned architectural modifications, the batch size was varied, as well as the number of hidden units. Further, the effects of including the mean absolute max height error [symbol] ₚ in the loss function are quantified. The results of the ablation and hyperparameter study are summarized in Table 1 below.

TABLE 1
Results of the ablation and hyperparameter study. [symbol] ₚ is the minimum mean landing
position error on the validation set, in yards. [symbol] ₕ is mean absolute max height
error on the validation set, in yards, for the model checkpoint with the lowest [symbol] [symbol] .

| | | Aero. Coeff. | Train | | | |
|---|---|---|---|---|---|---|
| Model | Description | Equations | Epochs | Loss | [symbol] ₚ | [symbol] ₕ |
| Phys-NN | base model | 8, 9, 10, 11 | 20 | [symbol] ₚ | 5.66 | 10.7 |
| Phys-NN-pM | C_{M} = [symbol] S | 9, 10, 24, 25 | 20 | [symbol] ₚ | 5.31 | 5.96 |
| Phys-NN-pM-cQ | [symbol] = C_{Q} [symbol] | 9, 10, 25, 26, 27 | 20 | [symbol] ₚ | 5.24 | 3.92 |
| Phys-NN-pM | units = {256, 128} | 9, 10, 24, 25 | 20 | [symbol] ₚ | 5.31 | 5.96 |
| Phys-NN-pM-2x | units = {512, 256} | 9, 10, 24, 25 | 20 | [symbol] ₚ | 5.23 | 6.69 |
| Phys-NN-pM-4x | units = {1024, 512} | 9, 10, 24, 25 | 20 | [symbol] ₚ | 5.24 | 6.53 |
| Phys-NN-pM-31 | units = {512, 256, 128} | 9, 10, 24, 25 | 20 | [symbol] ₚ | 5.45 | 4.83 |
| Phys-NN-pM-b256 | batch size = 256 | 9, 10, 24, 25 | 20 | [symbol] ₚ | 5.18 | 7.11 |
| Phys-NN-pM-b512 | batch size = 512 | 9, 10, 24, 25 | 20 | [symbol] ₚ | 5.22 | 6.71 |
| Phys-NN-pM | batch size = 1024 | 9, 10, 24, 25 | 20 | [symbol] ₚ | 5.31 | 5.96 |
| Phys-NN-pM-b2048 | batch size = 2048 | 9, 10, 24, 25 | 20 | [symbol] ₚ | 5.49 | 5.49 |
| Phys-NN-pM | loss = [symbol] ₚ | 9, 10, 24, 25 | 20 | [symbol] ₚ | 5.31 | 5.96 |
| Phys-NN-pM | loss = [symbol] ₚ + [symbol] ₕ | 9, 10, 24, 25 | 20 | [symbol] ₚ + [symbol] ₕ | 5.78 | 1.39 |
| Phys-Q | quadratic fit, loss = [symbol] ₚ | 20, 21, 22 | 50 | [symbol] ₚ | 6.96 | 3.61 |
| Phys-Q | quadratic fit, loss = [symbol] ₚ + [symbol] ₕ | 20, 21, 22 | 50 | [symbol] ₚ + [symbol] ₕ | 6.63 | 1.64 |
| NN | [symbol] = [symbol] ( [symbol] , [symbol] ) | [symbol] | 100 | [symbol] ₚ | 5.24 | — |
| Phys-NN+ | final model [symbol] loss = [symbol] ₚ | 9, 10, 25, 26, 27 | 50 | [symbol] ₚ | 4.91 | 3.95 |
| Phys-NN+ | final model, loss = [symbol] ₚ + [symbol] ₕ | 9, 10, 25, 26, 27 | 50 | [symbol] ₚ + [symbol] ₕ | 4.75 | 1.31 |

[symbol]

indicates data missing or illegible when filed

The best settings (shown in bold) were combined to produce the final model, Phys-NN+, which was trained for 50 epochs. The addition of the [symbol] ₕ loss dramatically improved the mean absolute max height error for both the Phys-Q and Phys-NN+ models. For the models trained using [symbol] ₚ only, the observed variation in the computed [symbol] ₕ values suggests that the problem could be underdefined. In other words, there is potential for golf ball trajectories of varying height to reach similar landing positions. Using the [symbol] ₕ loss is therefore recommended to constrain the problem and promote realistic simulation results. Furthermore, we find that using [symbol] ₕ has the added benefit of improving the landing position error [symbol] ₚ. While this was not the original intent, it is possible that [symbol] ₕ acts as a physical prior that helps steer the neural network optimization towards a global minimum. When using the [symbol] ₕ loss, the mean landing position error of Phys-NN+ was 4.75 yds, which is 28% more accurate than Phys-Q and 9% more accurate than using a neural network to predict the landing position directly (NN). Any remaining error is attributed to random noise resulting from measurement error and environmental factors such as wind, temperature, and humidity.

Advancements in deep learning have naturally led to the use of larger neural networks that use more memory and require specialized accelerated hardware, such as GPUs, for fast or “real-time” inference. In this application, however, the neural network used is very small in comparison to the ones commonly used in the deep learning literature. In fact, the neural network computation comprises just a few matrix multiplications. As a result, the computational overhead of our approach is not significant in practice.

Table 2 summarizes the latencies (processing time per simulated shot) of Phys-Q and Phys-NN+ running on a CPU (Intel i7-11850H) and GPU (NVIDIA RTX A2000).

TABLE 2
Latencies of Phys-Q and Phys-NN+ running on a
CPU (Intel i7-11850H) and GPU (NVIDIA RTX A2000).
Latencies averaged over 256 trials using randomly
selected launch conditions from the validation dataset.

| | 1 shot | 1024 shots | 1 shot | 1024 shots |
|---|---|---|---|---|
| | CPU | CPU | GPU | GPU |
| Model | (ms) | (μs) | (ms) | (μs) |
| Phys-Q | 25.2 | 97.8 | 49.8 | 73.6 |
| Phys-NN+ | 34.9 | 348 | 57.9 | 86.1 |

As can be seen, Phys-NN+ processes a single shot on a CPU in 35.9 ms, compared to 25.2 ms for Phys-Q. Both models process shots much faster than real-time as most golf shots remain in the air for more than 3 seconds (as shown in FIG. 4). When processing a batch of shots, Phys-NN+ suffers more on CPU due to the increased memory usage of the neural network. However, the batched latency is comparable with Phys-Q when using the GPU. Therefore, a GPU may be preferable when simulating many shots in parallel.

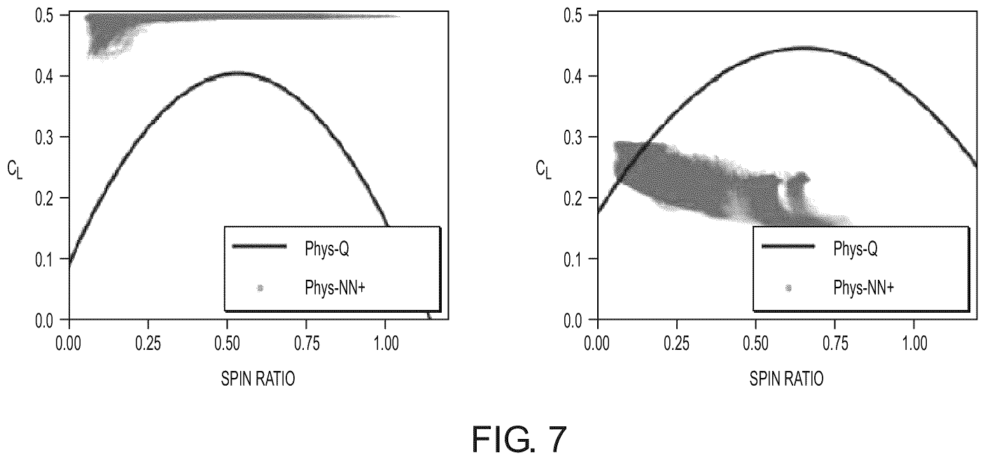

Finally, the lift and drag coefficients produced by the Phys-NN+ and Phys-Q models trained using the [symbol] ₚ+ [symbol] ₕ loss are compared. FIG. 7 plots the lift and drag coefficients produced by Phys-NN+ against the spin ratio for all simulation time steps in the validation set (573,308 data points). The polynomial curve fits of Phys-Q are overlaid for comparison. Interestingly, the neural network in Phys-NN+ nearly saturated the C_{L} sigmoid, resulting in many C_{L} values near 0.5. C_{D} had significantly more variance, potentially as a result of the saturated C_{L}. For this reason, it is possible that the coefficients generated by Phys-NN+ do not reflect the actual physics involved.

According to the above-described exemplary embodiments, a golf ball flight model is provided that integrates deep learning into the equations of motion to improve the accuracy of simulated golf ball trajectories. The inventive methodology for training a neural network advantageously estimates instantaneous aerodynamic coefficients using measured launch conditions and a landing position loss. Additionally, adding a second equally weighted loss for the max height error not only improves the heights of the simulated trajectories, but also reduces the landing position error. The disclosed examples have minimal computational overhead compared to existing models and runs much faster than what is required for practical applications.

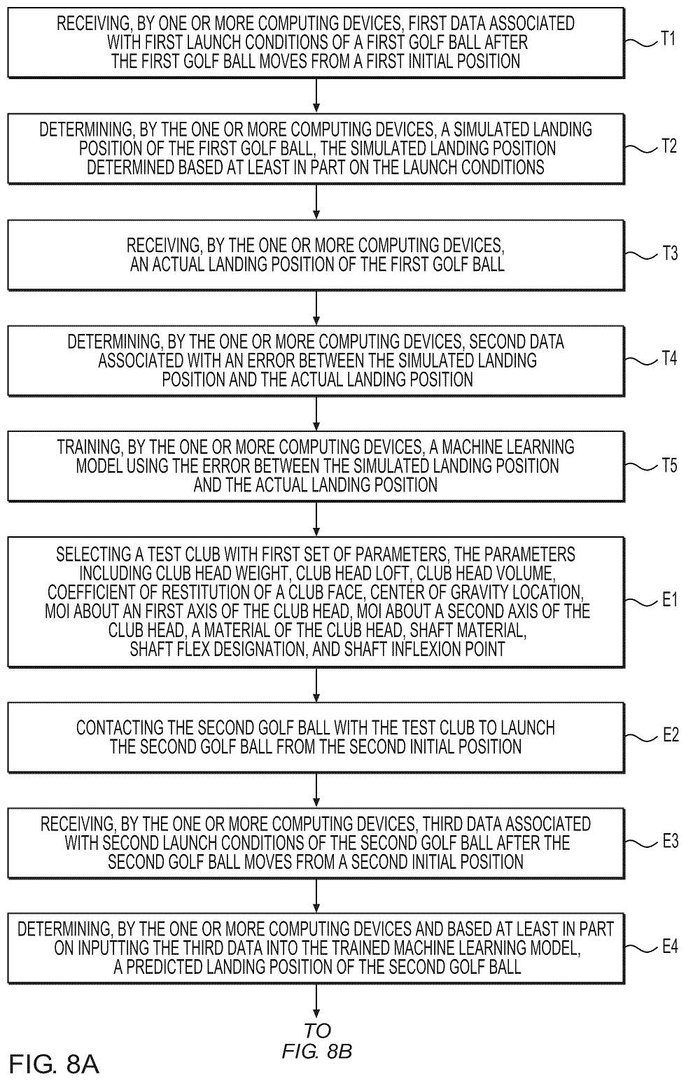

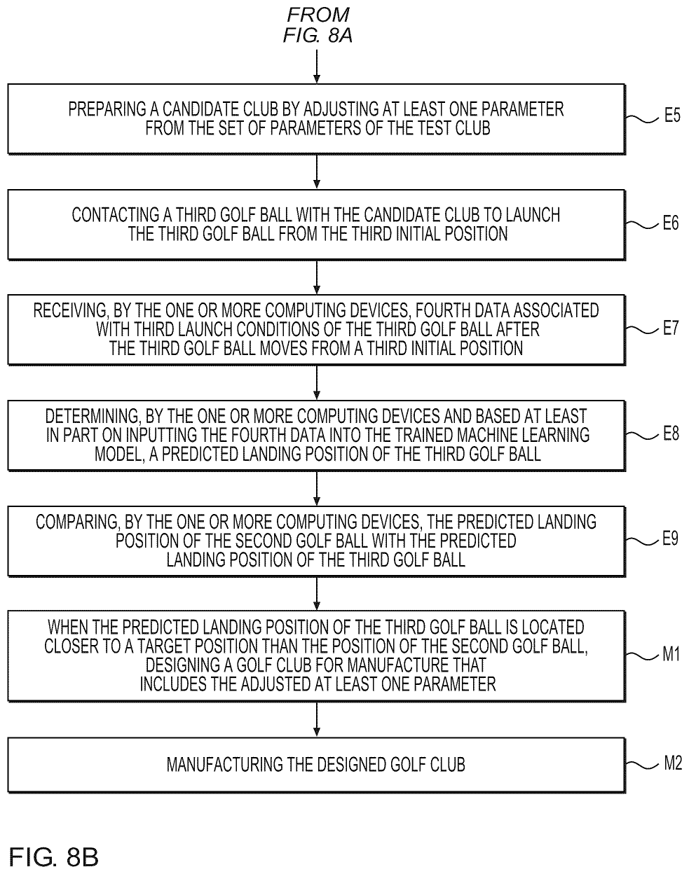

In addition to the aforementioned benefits to the technical field and to the processing speed and accuracy of the predictions, the above-described exemplary embodiments can be practically applied to golf club design. In particular, by more accurately predicting the trajectory of a golf ball, the predicted trajectory can be used to select or optimize one or more club properties to achieve a more desirable golf ball trajectory. An example of such a method is shown in FIG. 8.

In the training phase of the method (steps T1-T5), the AI model is trained. Specifically, in step T1, first data associated with first launch conditions of a first golf ball (or other projectile) after the first golf ball moves from a first initial position is received by one or more computing devices. In step T2, a simulated landing position of the first golf ball determined based at least in part on the launch conditions is determined by the one or more computing devices. In step T3, an actual landing position of the first golf ball is received by the one or more computing devices. In step T4, second data associated with an error between the simulated landing position and the actual landing position is determined by the one or more computing devices. In step T5, a machine learning model using the error between the simulated landing position and the actual landing position is trained by the one or more computing devices. While the machine learning model has been described as being trained using error between a simulated landing position and an actual landing position, it is to be understood that the machine learning model may be trained using error (e.g., error between simulated and actual ball flight) that is calculated at any point along the flight path of the golf ball (i.e., after the golf ball has moved from an initial position). All of these steps have been discussed in detail above.

In the evaluation phase of the method (steps E1-E9), the trained AI model is used to evaluate one or more design parameters. Specifically, in step E1, a test club is selected with a first set of parameters, the first set of parameters including, but not limited to, club head weight, club head loft, club head volume, coefficient of restitution of a club face, center of gravity location, MOI about a first axis of the club head, MOI about a second axis of the club head, a material of the club head, shaft material, shaft flex designation, and shaft inflexion point. In step E2, the second golf ball is contacted with the test club to launch the second golf ball from the second initial position. In step E3, third data associated with second launch conditions of the second golf ball after the second golf ball moves from a second initial position is received by the one or more computing devices. In step E4, based at least in part on inputting the third data into the trained machine learning model, a predicted landing position of the second golf ball is determined by the one or more computing devices. In step E5, a candidate club is prepared by adjusting at least one parameter from the set of parameters of the test club. In step E6, a third golf ball is contacted with the candidate club to launch the third golf ball from the third initial position. In step E7, fourth data associated with third launch conditions of the third golf ball after the third golf ball moves from a third initial position is received by the one or more computing devices. In step E8, based at least in part on inputting the fourth data into the trained machine learning model, a predicted landing position of the third golf ball is determined by the one or more computing devices. In step E9, the predicted landing position of the second golf ball is compared with the predicted landing position of the third golf ball by the one or more computing devices.

In the design and manufacturing phase of the method (steps M1-M2), parameters determined to result in superior landing position can be incorporated into a club for design. In particular, in step M1, when the predicted landing position of the third golf ball is located closer to a target position than the position of the second golf ball, a golf club can be designed for manufacture that includes the adjusted at least one parameter. In step M2, the designed golf club can be manufactured.

In the above method, the simulated and actual trajectory of the ball could be used instead of the simulated and actual landing position. Further, a similar method could be used to design a manufacture a golf ball by evaluating one or more properties of the ball including for example, dimple shape, dimple size, dimple pattern, cover material, cover hardness, core material, core hardness, etc.

### RELATED ART LISTING

1: Alastair COCHRAN and John STOBBS. The Search for the Perfect Swing. J. B. Lippincott Company, 1968.
2: C B Daish. The physics of ball games. English University Press, 1972.
3: Herman Erlichson. Maximum projectile range with drag and lift, with particular application to golf. American Journal of Physics, 51(4):357-362, 1983.
4: A J Smits and D R Smith. A new aerodynamic model of a golf ball in flight. In Science and Golf II: Proceedings of the World Scientific Congress of Golf, pages 340-347. 1994.
5: S J Quintavalla. A generally applicable model for the aerodynamic behavior of golf balls. In Science and Golf IV: Proceedings of the World Scientific Congress of Golf, pages 341-348, 2002.
6: T Sajima, T Yamaguchi, M Yabu, and M Tsunoda. The aerodynamic influence of dimple design on flying golf ball. In The Engineering of Sport 6: Volume 1: Developments for Sports, pages 143-148. Springer, 2006.
7: Spencer Ferguson, William McNally, and John McPhee. Predicting the flight of a golf ball: Comparing a physics-based aerodynamic model to a neural network. In Engineering of Sport 14: Proceedings of the 14th Conference of the International Sports Engineering Association, 2022. https://doi.org/10.5703/1288284317493
8: Yann LeCun, Yoshua Bengio, and Geoffrey Hinton. Deep learning. nature, 521(7553):436-444, 2015

What is claimed is:

1. A computer-implemented method comprising:
receiving, by one or more computing devices, first data associated with first launch conditions of a first golf ball after the first golf ball moves from a first initial position;
determining, by the one or more computing devices, a simulated landing position of the first golf ball, the simulated landing position determined based at least in part on the launch conditions;
receiving, by the one or more computing devices, an actual landing position of the first golf ball;
determining, by the one or more computing devices, second data associated with an error between the simulated landing position and the actual landing position;
training, by the one or more computing devices, a machine learning model using the error between the simulated landing position and the actual landing position;
receiving, by the one or more computing devices, third data associated with second launch conditions of a second golf ball after the second golf ball moves from a second initial position; and
determining, by the one or more computing devices and based at least in part on inputting the third data into the trained machine learning model, a predicted landing position of the second golf ball.

2. The computer-implemented method of claim 1, wherein the machine learning model is trained to output predicted aerodynamic coefficients of the second golf ball based at least in part on the third data associated with the second launch conditions of the second golf ball, the predicted landing position being based at least in part on the predicted aerodynamic coefficients.

3. The computer-implemented method of claim 1, wherein the machine learning model is configured to:
determine first aerodynamic coefficients of the second golf ball at a first time, the first time being after the second golf ball moves from the initial position and before the second golf ball lands; and
determine second aerodynamic coefficients of the second golf ball at a second time, the second time being different than the first time and being after the second golf ball moves from the initial position and before the second golf ball lands, wherein the predicted landing position of the second golf ball is based at least in part on the first aerodynamic coefficients and the second aerodynamic coefficients.

4. The computer-implemented method of claim 1, wherein the first launch conditions and the second launch conditions comprise one or more of a ball speed, a launch angle, an azimuth, a total spin, a spin-tilt axis, a linear velocity, or an angular velocity.

5. The computer-implemented method of claim 3, wherein the first aerodynamic coefficients and the second aerodynamic coefficients comprise one or more of drag or lift.

6. The computer-implemented method of claim 1, further comprising determining, by the one or more computing devices and based at least in part on the trained machine learning model, a predicted ball flight of the second golf ball, the predicted ball flight including a predicted location of the second golf ball at various time steps between a first time and a second time.

7. The computer-implemented method of claim 6, wherein the first time is associated with initial movement of the second ball from the initial position and the second time is associated with a landing of the second golf ball.

8. The computer-implemented method of claim 1, wherein the machine learning model comprises one or more of a supervised learning algorithm, an unsupervised learning algorithm, a semi-supervised learning algorithm, or a reinforcement learning algorithm.

9. The computer-implemented method of claim 1, wherein the one or more computing devices determine the simulated landing position using a mathematical physics model.

10. The computer-implemented method of claim 1, wherein the one or more computing devices determine the predicted landing position using a mathematical physics model.

11. The computer-implemented method of claim 1, further comprising:
receiving, by the one or more computing devices, fourth data associated with launch conditions of a first plurality of golf balls;
determining, by the one or more computing devices, a simulated landing position for each golf ball of the first plurality of golf balls;
receiving, by the one or more computing devices, an actual landing position for each golf ball of the first plurality of golf balls; and
determining, by the one or more computing devices, fifth data associated with error between the simulated landing position and the actual landing position, the fifth data determined for each golf ball of the first plurality of golf balls, wherein the machine learning model is trained using the fifth data.

12. A computer-implemented method comprising:
receiving, by one or more computing devices, first data associated with first launch conditions of a first projectile after the first projectile moves from an initial position;
determining, by the one or more computing devices, a simulated landing position of the first projectile, the simulated landing position determined based at least in part on the launch conditions;
receiving, by the one or more computing devices, an actual landing position of the first projectile;
determining, by the one or more computing devices, second data associated with an error between the simulated landing position and the actual landing position;
training, by the one or more computing devices, a machine learning model using the error between the simulated landing position and the actual landing position;
receiving, by the one or more computing devices, third data associated with second launch conditions of a second projectile after the second projectile moves from an initial position; and
determining, by the one or more computing devices and based at least in part on the trained machine learning model, a predicted landing position of the second projectile.

13. The computer-implemented method of claim 12, wherein the machine learning model is trained to output predicted aerodynamic coefficients of the second projectile based at least in part on the third data associated with the second launch conditions of the second projectile, the predicted landing position being based at least in part on the predicted aerodynamic coefficients.

14. The computer-implemented method of claim 1, further comprising:
selecting a first club with first set of parameters, the parameters including club head weight, club head loft, club head volume, coefficient of restitution of a club face, center of gravity location, MOI about an first axis of the club head, MOI about a second axis of the club head, a material of the club head, shaft material, shaft flex designation, and shaft inflexion point;
contacting the second golf ball with the first club to launch the second golf ball from the second initial position;
preparing a second club by adjusting at least one parameter from the set of parameters of the first club;
contacting a third golf ball with the second club to launch the third golf ball from the third initial position;
receiving, by the one or more computing devices, fourth data associated with third launch conditions of the third golf ball after the third golf ball moves from a third initial position; and
determining, by the one or more computing devices and based at least in part on inputting the fourth data into the trained machine learning model, a predicted landing position of the third golf ball;
comparing the predicted landing position of the second golf ball with the predicted landing position of the third golf ball; and
when the predicted landing position of the third golf ball is located closer to a target position than the position of the second golf ball, designing a golf club for manufacture that includes the adjusted at least one parameter.

15. The computer-implemented method of claim 1, further comprising:
virtually modeling a first club with first set of parameters, the parameters including club head weight, club head loft, club head volume, coefficient of restitution of a club face, center of gravity location, MOI about an first axis of the club head, MOI about a second axis of the club head, a material of the club head, shaft material, shaft flex designation, and shaft inflexion point;
simulating contacting the second golf ball with the first club to launch the second golf ball from the second initial position;
virtually modeling a second club by adjusting at least one parameter from the set of parameters of the first club;
simulating contacting a third golf ball with the second club to launch the third golf ball from the third initial position;
receiving, by the one or more computing devices, fourth data associated with third launch conditions of the third golf ball after the third golf ball moves from a third initial position; and
determining, by the one or more computing devices and based at least in part on inputting the fourth data into the trained machine learning model, a predicted landing position of the third golf ball;
comparing the predicted landing position of the second golf ball with the predicted landing position of the third golf ball; and
when the predicted landing position of the third golf ball is located closer to a target position than the position of the second golf ball, designing a golf club for manufacture that includes the adjusted at least one parameter.
